(19) United States
(12) Patent Application Publication
(10) Pub. No.: US 2026/0343425 A1
(43) Pub. Date: Oct. 29, 2026

(54) SELECTION OF FREQUENCY CHANNEL REUSE SCHEME AND TRANSMIT POWERS

(71) Applicant: Telefonaktiebolaget LM Ericsson (publ), Stockholm (SE)

(72) Inventors: Magnus NILSSON, Kungsbacka (SE); Mikael COLDREY, Borås (SE)

(73) Assignee: Telefonaktiebolaget LM Ericsson (publ), Stockholm (SE)

(21) Appl. No.: 19/157,289

(22) PCT Filed: Mar. 13, 2023
(86) PCT No.: PCT/EP2023/056375

§ 371 Date: Aug. 15, 2025

(51) Int. Cl. H04W 52/24; H04W 52/26

(52) U.S. Cl. CPC H04W 52/243; H04W 52/267

(57) ABSTRACT

There is provided techniques for selecting a frequency channel reuse scheme, and transmit powers, for a fixed wireless network. At least partly overlapping frequency channels are available for communication over wireless links in the fixed wireless network. A method is performed by a network control unit. The method comprises obtaining information of interference among the wireless links, traffic demand per wireless link, and link gain per wireless link. The method comprises selecting the frequency channel reuse scheme by determining which of the frequency channels to be allocated to which of the wireless links, and determining the transmit powers to be used for each of the wireless links, based on the obtained information.

### TECHNICAL FIELD

Embodiments presented herein relate to a method, a network control unit, a computer program, and a computer program product for selecting a frequency channel reuse scheme and transmit powers for a fixed wireless network.

### BACKGROUND

Data traffic in wireless networks is growing rapidly. The increase in traffic implies a densification of the wireless network, using more and more transceiver points. At the same time, there is a trend of higher frequency reuse in wireless networks to save costs. The capacity demand in the transport network is increasing and the amount of spectrum is limited. Wider frequency channels in limited spectrum implies fewer frequency channels. Therefore, it is of interest to increase the frequency channel reuse, to enable wider frequency channels in the network. But by doing so, the amount of interference between the wireless links will also increase.

Fixed wireless networks, such as microwave networks, fixed wireless access networks, and fixed wireless backhaul networks, are traditionally designed so that the wireless links are, in principle, interference free. Neighboring wireless links are assigned different frequency channels to not cause any interference to each other. Requiring interference-free wireless links causes the frequency spectrum to be used inefficiently. Hereinafter is considered a scenario where a network operator has a number of frequency channels available that the network operator can adaptively mix and use.

Current fixed wireless networks avoid interference by careful planning, but the increased densification and higher frequency channel reuse will inevitably lead to higher interference between the wireless links. Hence, fixed wireless networks will require new tools that allow for control and mitigation of interference.

Further, existing power control methods combined with higher frequency channel reuse can lead to power rushes, which in turn will cause unnecessary interference in fixed wireless networks.

Hence, to allow further densification of wireless networks, and thus higher capacity, there is a need for effective reuse of frequency.

### SUMMARY

An object of embodiments herein is to address the above issues.

A particular object is to enable the available spectrum to be used more efficiently.

A particular object is to provide higher capacity in a fixed wireless network.

According to a first aspect there is presented a method for selecting a frequency channel reuse scheme, and transmit powers, for a fixed wireless network. At least partly overlapping frequency channels are available for communication over wireless links in the fixed wireless network. The method is performed by a network control unit. The method comprises obtaining information of interference among the wireless links, traffic demand per wireless link, and link gain per wireless link. The method comprises selecting the frequency channel reuse scheme by determining which of the frequency channels to be allocated to which of the wireless links, and determining the transmit powers to be used for each of the wireless links, based on the obtained information.

According to a second aspect there is presented a network control unit for selecting a frequency channel reuse scheme, and transmit powers, for a fixed wireless network. At least partly overlapping frequency channels are available for communication over wireless links in the fixed wireless network. The network control unit comprises processing circuitry. The processing circuitry is configured to cause the network control unit to obtain information of interference among the wireless links, traffic demand per wireless link, and link gain per wireless link. The processing circuitry is configured to cause the network control unit to select the frequency channel reuse scheme by determining which of the frequency channels to be allocated to which of the wireless links, and determining the transmit powers to be used for each of the wireless links, based on the obtained information.

According to a third aspect there is presented a network control unit for selecting a frequency channel reuse scheme, and transmit powers, for a fixed wireless network. At least partly overlapping frequency channels are available for communication over wireless links in the fixed wireless network. The network control unit comprises an obtain module configured to obtain information of interference among the wireless links, traffic demand per wireless link, and link gain per wireless link. The network control unit comprises a select module configured to select the frequency channel reuse scheme by determining which of the frequency channels to be allocated to which of the wireless links, and determining the transmit powers to be used for each of the wireless links, based on the obtained information.

According to a fourth aspect there is presented a computer program for selecting a frequency channel reuse scheme and transmit powers for a fixed wireless network. At least partly overlapping frequency channels are available for communication over wireless links in the fixed wireless network. The computer program comprises computer code which, when run on processing circuitry of a network control unit, causes the network control unit to perform actions. One action comprises the network control unit to obtain information of interference among the wireless links, traffic demand per wireless link, and link gain per wireless link. One action comprises the network control unit to select the frequency channel reuse scheme by determining which of the frequency channels to be allocated to which of the wireless links, and determining the transmit powers to be used for each of the wireless links, based on the obtained information.

According to a fifth aspect there is presented a computer program product comprising a computer program according to the fourth aspect and a computer readable storage medium on which the computer program is stored. The computer readable storage medium could be a non-transitory computer readable storage medium.

Advantageously, these aspects do not suffer from the above-mentioned issues.

Advantageously, these aspects enable the available spectrum to be used more efficiently.

Advantageously, these aspects yield higher capacity in the fixed wireless network. This is achieved by using the available spectrum more efficiently.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a network according to embodiments;

FIG. 2 schematically illustrates frequency channel reuse schemes in a fixed wireless network according to embodiments;

FIGS. 3, 4, and 5 show simulation results according to embodiments;

FIGS. 6 and 7 are flowcharts of methods according to embodiments;

FIG. 8 is a schematic diagram showing functional units of a network control unit according to an embodiment;

FIG. 9 is a schematic diagram showing functional modules of a network control unit according to an embodiment; and

FIG. 10 shows one example of a computer program product comprising computer readable storage medium according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

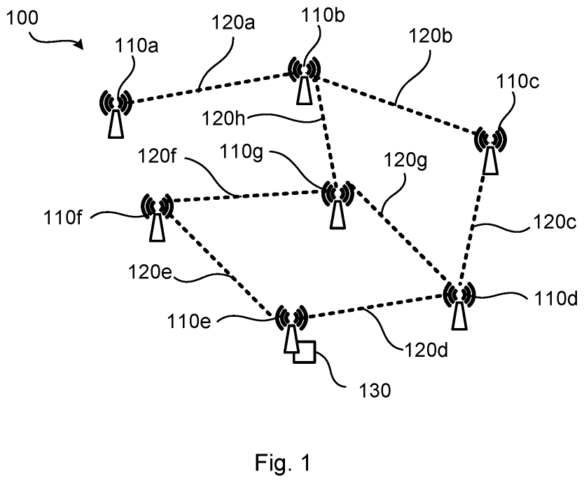

FIG. 1 is a schematic diagram illustrating a network 100 where embodiments presented herein can be applied. The network 100 comprises wireless links 120a:120h (eight in total) extending between transceiver points 110a:110g (seven in total). In some examples, the network 100 is a fixed wireless network. Frequency channels (or carriers) can be assigned to the wireless links 120a:120h. These frequency channels might either all be of the same bandwidth, or there are at least two frequency channels with different bandwidths. In any case, all frequency channels share the same spectrum. How the frequency channels are assigned to the wireless links 120a:120h is defined by a frequency channel reuse scheme.

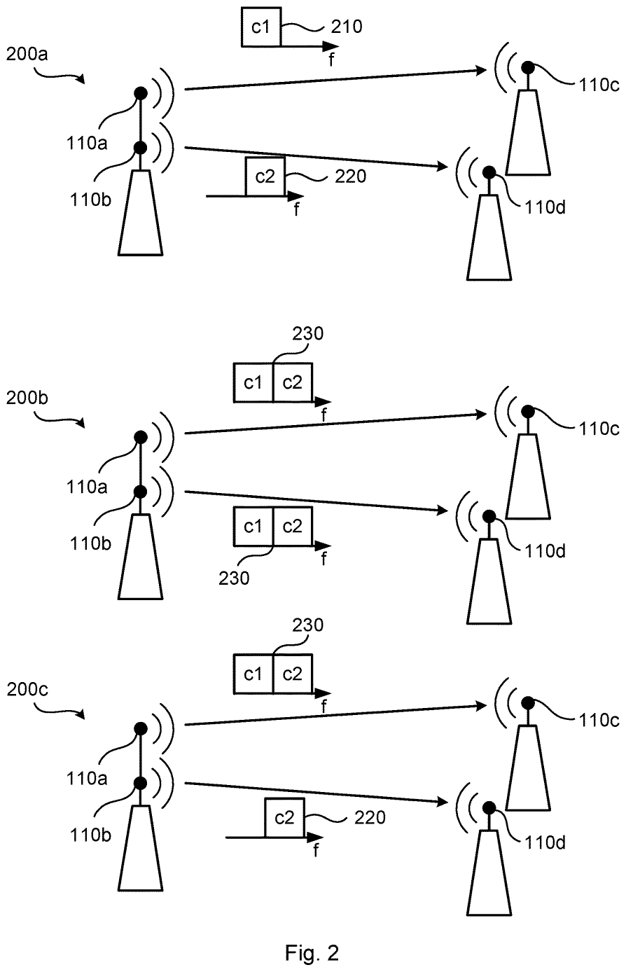

As an introductory example, consider the fixed wireless network with two wireless links as illustrated in FIG. 2, where three different frequency channel reuse schemes 200a, 200b, 200c are illustrated. A first wireless link extends between transceiver points 110a and 110c. A second wireless link extends between transceiver points 110b and 110d. Each wireless link has 112 MHz of total bandwidth available. Each 20 frequency channel reuse scheme 200a:200c represents a different ways of assigning frequency channels (or carriers) in the fixed wireless network. According to frequency channel reuse scheme 200a the available bandwidth can be split into two different 56 MHz frequency channels where separate frequency channels, c1, c2, are assigned to each of the wireless links. This is referred to as reuse 2. Alternatively, according to frequency channel reuse scheme 200b, both wireless links are allocated both frequency channels, i.e., 2·56=112 MHz bandwidth. This is referred to as reuse 1. In frequency channel reuse scheme 200b there will be interference between the two wireless links. The amount of interference depends on the antenna discrimination, channel gains, and output powers. In this example frequency channel reuse scheme 200b can be implemented either by a single 112 MHz channel or two 56 MHz channels (i.e., using carrier aggregation). However, two 56 MHz channels might be preferred for full adaptation since then it is also possible to mix reuse 1 with a reuse 2 scenario, where one wireless link can use 112 MHz bandwidth and the other wireless link can use 56 MHz bandwidth. This is the case for frequency channel reuse scheme 200c, also referred to as mixed reuse. It is here noted that the illustrated frequency channel reuse schemes 200a:200c are just examples.

As noted above, there is a need for effective reuse of frequency channels.

The embodiments disclosed herein therefore relate to techniques for selecting a frequency channel reuse scheme and transmit powers for a fixed wireless network 100. In order to obtain such techniques there is provided a network control unit 130, 800, 900, a method performed by the network control unit 130, 800, 900, a computer program product comprising code, for example in the form of a computer program, that when run on a network control unit 130, 800, 900, causes the network control unit 130, 800, 900 to perform the method.

The embodiments disclosed herein enables adaptive frequency channel allocation that employs adaptive allocations between different frequency channel reuse schemes 200a:200c in a fixed wireless network. The adaptive allocation is based on current traffic demands, capacity utilizations, and channel and interference qualities in the fixed wireless network.

The fixed wireless network shown in FIG. 2 with two 56 MHz carriers available per wireless link is taken as an illustrative example of which frequency channel reuse scheme 200a:200c to use for the current set of parameters in terms of current traffic demands, capacity utilizations, and channel and interference qualities in the fixed wireless network.

Each given wireless link is assumed to have a certain traffic demand that varies over time. To meet the traffic demand, a certain capacity over the given wireless link is needed. The capacities supported for each frequency channel is a discrete number, where each capacity corresponds to a certain coding and modulation configuration. Each capacity requires a certain signal to interference plus noise ratio (SINR) at the receiver. Hence, the SINR is representative of the traffic demand, and vice versa. One example of a mapping between capacity and SINR is provided in Table 1.

TABLE 1
Different capacities supported by a frequency channel
and the required SINR to fulfill that capacity.

| C₁ | C₂ | C₃ | C₄ | C₅ | C₆ | C₇ |
|---|---|---|---|---|---|---|
| SINR_{req1} | SINR_{req2} | SINR_{req3} | SINR_{req4} | SINR_{req5} | SINR_{req6} | SINR_{req7} |

The total capacity over a wireless link is the sum of the capacities of the two frequency channels, see Eq. 1Fel! Hittar into referenskälla. There can be several capacity combinations for the different frequency channel that can meet the traffic demand.

Cₗ=C_{l,c1}+C_{l,c2} (1)

where Cₗ is the total capacity for wireless link l summed over the first frequency channel (c1) and the second frequency channel (c2), respectively.

When a wireless link assigns a capacity for one of its frequency channels, then the capacity per frequency channel for the wireless link can be mapped to a required SINR, as in Table 1.

The SINR required to fulfill the capacity for the first frequency channel of each wireless link is given by Eq. 2 and Eq. 3. In these equations, all parameters are known except the transmit powers P_{l1,c1} and P_{l2,c1}. The SINRs for each wireless link for the second frequency channel is given by Eq. 4 and Eq. 5, where all the parameters are known except the transmit powers P_{l1,c2} and P_{l2,c2}. Hence, a first equation system is formed by Eqs. 2 and 3, and a second equation system is formed by Eqs. 4 and 5.

$$\frac{{h}_{l 1 , l 2 , c 1} {P}_{l 1 , c 1}}{{h}_{l 2 , l 1 , c 1} {P}_{l 2 , c 1} + {n}_{l 2 , c 1}} = S I N {R}_{req , l 2 , c 1} \qquad ( 2 )$$

$$\frac{{h}_{l 2 , l 2 , c 1} {P}_{l 2 , c 1}}{{h}_{l 1 , l 2 , c 1} {P}_{l 1 , c 1} + {n}_{l 2 , c 1}} = {SINR}_{req , l 2 , c 1} \qquad ( 3 )$$

$$\frac{{h}_{l 1 , l 1 , c 1} {P}_{l 1 , c 12}}{{h}_{l 2 , l 1 , c 2} {P}_{l 2 , c 2} + {n}_{l 1 , c 2}} = {SINR}_{req , l 1 , c 2} \qquad ( 4 )$$

$$\frac{{h}_{l 2 , l 2 , c 2} {P}_{l 2 , c 2}}{{h}_{l 1 , l 2 , c 2} {P}_{l 1 , c 2} + {n}_{l 2 , c 2}} = {SINR}_{req , l 2 , c 2} \qquad ( 5 )$$

where h_{li,li,cm} is total link gain for wireless link i for frequency channel m, h_{lj,li,cm} is total link gain between link j and i for frequency channel m, P_{li,cm} and P_{lj,cm} are transmit powers for frequency channel m of link i and j, respectively, n_{li,cm} is the noise power for wireless link i and frequency channel m, and SINR_{req,li,cm} is the required SINR for wireless link i and frequency channel m (e.g., given by the traffic demand that is mapped to SINR via the capacity as in below Table 1).

The two equation systems can be solved for the transmit powers independently of each other. For the solution to be valid, all transmit powers must be positive numbers. There could also be other requirements, for example, requirements that depend on the number of radios per wireless link, for the solution to be valid. In case one radio is used per frequency channel per wireless link, the power for each frequency channel must be within P_{t,dBm,min}≤P_{t,dBm}≤P_{t,dBm,max}. If there is one radio per wireless link, then the sum of the transmit powers for each frequency channel must be within P_{t,dBm,min}≤P_{t,dBm}≤P_{t,dBm,max}. If the transmit powers are within the restrictions, there is a valid solution to the traffic demand for the wireless links in the fixed wireless network. If any of the calculated transmit powers is outside the transmit power restriction, then there is no valid solution to the requested SINR. In such case, another a frequency channel reuse scheme fulfilling the traffic demand should be tried. If all possible frequency channel reuse schemes fulfilling the traffic demand are tried without success, then the capacity of some of the wireless links must be reduced below the traffic demand. A scheduler can here be used to decide which wireless links that should have prioritized capacity. In case several possible frequency channel reuse schemes yield valid solutions to meet the traffic demand, then the frequency channel reuse scheme with lowest transmit power could be selected.

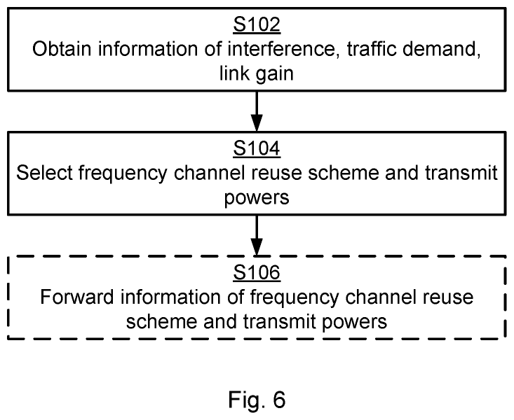

FIGS. 3, 4, and 5 shows simulation results of possible capacities for the examples illustrated in FIG. 2 for different antenna discriminations between the wireless links. The antenna discrimination represents the isolation between the two wireless links that is provided by the antenna radiation patterns. The lower the antenna discrimination, the more interference between the wireless links, and vice versa. The solid lines illustrate the possible rates for reuse 1, the dash-dotted lines illustrate the possible rates for reuse 2 and the dashed and dotted lines show the rate combinations when mixing reuse 1 and reuse 2 (i.e., mixed reuse). FIG. 3 shows the possible rate combinations with an antenna discrimination of 20 dB. If a capacity above 500 Mbps (Megabits per second) is requested for both wireless links, it is favorable to use reuse 2 (or even mixed use). Instead, if a capacity above 600 Mbps is requested for one of the wireless links whilst a capacity of no more than 150 Mbps is requested for the other wireless links, then it is favorable to use reuse 1 (or even mixed use). FIG. 4 shows the possible rate combinations with an antenna discrimination of 16 dB between the two wireless links. In this scenario is it preferable to use reuse 2, or mixed reuse, since both reuse 2 and mixed reuse are always better than reuse 1. FIG. 5 shows the possible rate combinations with an antenna discrimination of 26 dB between the two wireless links. In this scenario is it preferable to use frequency reuse 1 or mixed reuse unless if the traffic demand is low. By utilizing information as provided in FIGS. 3, 4, and 5 it is possible to, for a given traffic demand (as expressed in bits per second) then it can be possible to exclude some frequency channel reuse schemes. This knowledge can be used to reduce the number of possible equation systems to be solved. For example, if the traffic demand for the second wireless link is 700 Mbps and the traffic demand for the first wireless link is 100 Mbps, then, for an antenna discrimination of 20 dB as in FIG. 3, only the schemes for reuse 1 and mixed reuse need to be evaluated. Then, if neither of these schemes have valid solutions for the transmit powers, then the capacity demands need to be adjusted.

Based on the results that can be observed in FIGS. 3, 4, and 5, it can be concluded that different frequency channel reuse schemes for the two wireless links is favorable for different traffic demands.

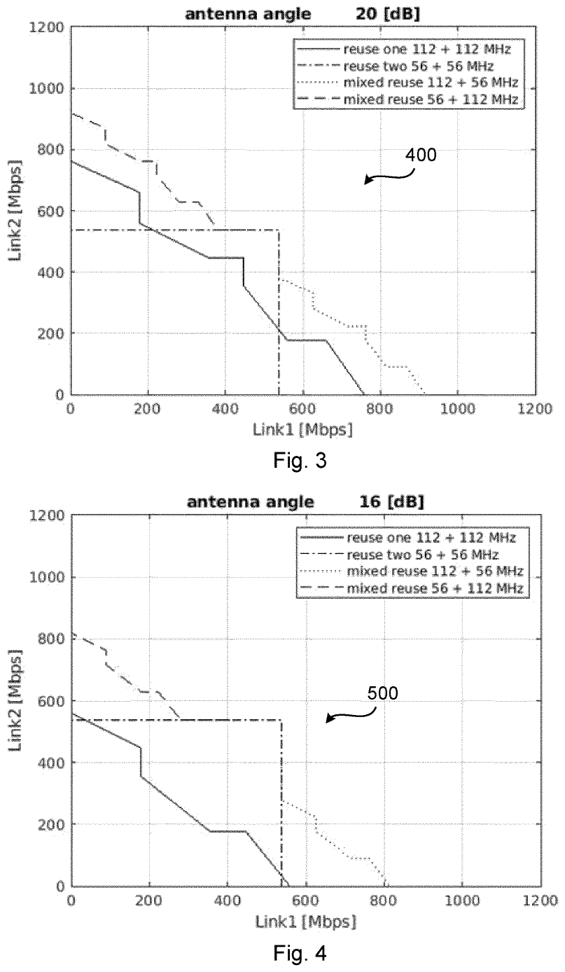

FIG. 6 is a flowchart illustrating embodiments of methods for selecting a frequency channel reuse scheme and transmit powers for a fixed wireless network 100. There can be different examples of fixed wireless networks 100. In some non-limiting examples, the fixed wireless network 100 is any of: a microwave network, a fixed wireless access network, a fixed wireless backhaul network. At least partly overlapping frequency channels 210:230 are available for communication over wireless links 120a:120h in the fixed wireless network 100. In some aspects each of the frequency channels 210:230 corresponds to a carrier. Therefore, the terms frequency channel and carrier can be used interchangeably. The methods are performed by the network control unit 130, 800, 900. The methods are advantageously provided as computer programs 1020.

S102: The network control unit 130, 800, 900 obtains information of interference among the wireless links 120a:120h, traffic demand per wireless link 120a:120h, and link gain per wireless link 120a:120h.

S104: The network control unit 130, 800, 900 selects the frequency channel reuse scheme 200a:200c by determining which of the frequency channels 210:230 to be allocated to which of the wireless links 120a:120h based on the obtained information and determines the transmit powers to be used for each of the wireless links 120a:120h also based on the obtained information.

Embodiments relating to further details of selecting a frequency channel reuse scheme and transmit powers for a fixed wireless network 100 as performed by the network control unit 130, 800, 900 will now be disclosed with continued reference to FIG. 6.

Once the frequency channel reuse scheme 200a:200c has been selected, information of the selected frequency channel reuse scheme 200a:200c can be provided to the transceiver points 110a:110g in the fixed wireless network 100. Therefore, in some embodiments, the network control unit 130, 800, 900 is configured to perform (optional) step S106.

S106: The network control unit 130, 800, 900 forwards information of the selected frequency channel reuse scheme 200a:200c to the transceiver points 110a:110g.

Upon having received the information, the transceiver points 110a:110g can operate in accordance with the selected frequency channel reuse scheme 200a:200c.

As disclosed above, there might be several available frequency channel reuse schemes 200a:200c, for example as illustrated in FIG. 2, from which the selected frequency channel reuse scheme 200a:200c is selected. That is, in some embodiments, the frequency channel reuse scheme 200a:200c is selected from a set of frequency channel reuse schemes 200a:200c available for the fixed wireless network 100. In this way, several frequency channel reuse schemes 200a:200c can be tested before a decision is made regarding which of the tested channel reuse schemes 200a:200c to select. That is, in some embodiments, the method comprises evaluating different frequency channel reuse schemes 200a:200c selected from the set of available frequency channel reuse schemes 200a:200c and determining one set of transmit powers to be used for each of the wireless links 120a:120h for each of the evaluated frequency channel reuse schemes 200a:200c. One selection criterion is to select the reuse schemes 200a:200c yielding lowest transmit powers. That is, in some embodiments, the frequency channel reuse scheme 200a:200c for which the set of transmit powers, or power consumption, is lowest is selected.

As disclosed above, the frequency channel reuse scheme 200a:200c and is selected, and the transmit powers are determined, based on information of interference among the wireless links 120a:120h, traffic demand per wireless link 120a:120h, and link gain per wireless link 120a:120h. In some aspects, also further information, referred to as side information, is taken into consideration. Aspects relating to different examples of side information will now be disclosed.

As disclosed above, it might be conditioned that the transmit powers are within some intervals. This could be one example of side information. Particularly, in some embodiments, the transmit powers are conditioned to be within a power interval, wherein the power interval depends on which number of radio units are available per wireless link 120a:120h.

As further disclosed above, if all possible frequency channel reuse schemes fulfilling the traffic demand are tried without success, then the capacity of some of the wireless links must be reduced below the traffic demand. This could be one example of side information. Particularly, in some embodiments, when the set of transmit powers for all evaluated frequency channel reuse schemes 200a:200c are determined to be outside the power interval, the traffic demand per wireless link 120a:120h is reduced until the transmit powers for at least one of the evaluated frequency channel reuse schemes 200a:200c are determined to be inside the power interval.

As further disclosed above, the lower the antenna discrimination, the more interference between the wireless links, and vice versa. Antenna discrimination could therefore be one example of side information. Particularly, in some embodiments, each of the different frequency channel reuse schemes 200a:200c is associated with capacity characteristics 400:600 provided per antenna discrimination, and which of the frequency channel reuse schemes 200a:200c that are evaluated is determined based on the capacity characteristics 400:600 and the antenna discrimination. The antenna discrimination corresponds to the interference among the wireless links 120a:120h.

As further disclosed above, for example with reference to Eqs. 2, 3, and 4, the transmit powers could further be determined based on thermal noise power per frequency channel and per wireless link 120a:120h. However, in other aspects it is assumed that the thermal noise power equally affects each frequency channel and each wireless link 120a:120h.

Which combination of frequency channel reuse scheme and output power to use for the different wireless links in the fixed wireless network can be calculated based on the total link gain between the wireless links. How to calculate the total link gain will be shown next.

The free space pathloss (FSLP) is part of the link gain and the FSLP can be calculated as in Eq. 6.

$$FSPL = 10 {{log}_{10} ( \frac{4 π df}{c} )}^{2} , \qquad ( 6 )$$

where d is the distance in meters, f is the frequency in Hz and c is the speed of light.

The link gain in dB, between two wireless links is defined in Eq. 7.

link gain=antGainₜₓ(θₜₓ)+antGainᵣₓ(θᵣₓ)−FSPL_{dB}, (7)

where antGainₜₓ(θₜₓ) is the transmit antenna gain for angle θₜₓ, antGainᵣₓ(θᵣₓ) is the receiver antenna gain for angle θᵣₓ, θₜₓ is the angle from the boresight of the transmit antenna pointing towards the receiver antenna, θᵣₓ is the angle from the boresight of the receive antenna pointing towards the transmitter, and FSPL is the free space pathloss as defined in Eq. 6.

The link gain is calculated between all Nₗᵢₙₖₛ wireless links in the fixed wireless network and can be represented by a total link gain matrix of size Nₗᵢₙₖₛ×Nₗᵢₙₖₛ, as in Eq. 8.

$${H}_{linkgain} = [ \begin{matrix}{h}_{l 1 , l 1 , c m} & ⋯ & {h}_{l {N}_{l i n k s} , l 1 , c m} \\ ⋮ & ⋱ & ⋮ \\ {h}_{l 1 , l {N}_{l i n k s} , c m} & ⋯ & {h}_{l {N}_{l i n k s} , l {N}_{l i n k s} , c m}\end{matrix} ] , \qquad ( 8 )$$

where h_{li,li,cm} is the link gain for wireless link li (1≤i≤Nₗᵢₙₖₛ) on frequency channel cm, h_{lj,li,cm} is the link gain (interference) from wireless link lj towards wireless link li, (i≠j), (1≤i, j≤Nₗᵢₙₖₛ) on frequency channel cm.

Given the total link gain in the fixed wireless network, the transmit power for each wireless link can be calculated, based on the required SINR to fulfill a specific capacity; for example according to the mapping in Table 1.

The transmit powers could be determined by solving equation systems, where there are as many equation systems as frequency channels, and as many equations per equation system as there are wireless links 120a:120h. As above, in the equation systems, the traffic demand per wireless link 120a:120h can be represented by a respective SINR value. Generally, the transmit powers could then be determined by solving Eq. 9.

$$\frac{{h}_{li , li , cm} + {P}_{l i , c m}}{{\sum }_{j , j \neq i} {h}_{l j , li , cm} {P}_{lj , cm} + {n}_{l i , c m}} = {SINR}_{req , li , cm} \qquad ( 9 )$$

where h_{li,li,cm} is total link gain for wireless link i for frequency channel m, h_{lj,li,cm} is total link gain between link j and i for frequency channel m, P_{li,cm} and P_{lj,cm} are transmit powers for frequency channel m of link i and j, respectively, n_{li,cm} is thermal noise power for wireless link i and frequency channel m, and SINR_{req,li,cm} is the required SINR for wireless link i and frequency channel m (e.g., given by the traffic demand that is mapped to SINR via the capacity as in above Table 1). The total link gain also included any fading or blocking.

By considering the SINR for all wireless links in the fixed wireless network using the same channel frequency, an equation system can be formed, where the number of equation systems equals the number of frequency channels, where the number of equations per equation system equals the number of wireless links, and where the transmit power for each wireless link is unknown and solved by solving the equation systems. Each of the equation systems is formed and solved independently of each other, as for the above example represented by Eqs. 2, 3, 4, and 5 for two wireless links.

Each transmit power might be constrained to P_{t,dBm,min}<P_{t,dBm}<P_{t,dBm,max}. A solution to the equation systems is valid if all transmit powers are inside the power constraint.

If a valid solution does not exist, the capacities for at least some of the wireless links is reduced so that the power constraints can be met. For which wireless links the capacities should be reduced can be decided by a scheduler or some priority function which is related to traffic priority classes.

One illustrative embodiment for selecting a frequency channel reuse scheme (and transmit powers for a fixed wireless network as performed by the network control unit will be disclosed next with reference to the flowchart of FIG. 7.

S201: The traffic demand for each wireless link is obtained.

S202: A set of available frequency channel reuse schemes where all frequency channel reuse schemes fulfil the traffic demand is selected.

S203: One frequency channel reuse scheme is selected from the set of available frequency channel reuse schemes.

S204: The traffic demand is mapped to a required SINR per frequency channel per wireless link.

S205: The transmit powers are determined by solving systems of equations for the selected frequency channel reuse scheme, based on interference among the wireless links, the traffic demand per wireless link, and link gain per wireless link, as in Eq. 12.

S206: It is checked whether the determined transmit powers fulfil power constraints. Step S207 is entered if the constraints for all the transmit power are fulfilled. Else, step S208 is entered.

S207: The tested frequency channel reuse scheme is removed from the set of available frequency channel reuse schemes and entered in a set of candidate frequency channel reuse schemes. If the set of available frequency channel reuse schemes is not empty, another frequency channel reuse scheme is selected and step S204 is entered again. Else, step S209 is entered.

S208: The tested frequency channel reuse scheme is removed from the set of available frequency channel reuse schemes. If the set is not empty, another frequency channel reuse scheme is selected and step S204 is entered again. Else, step S209 is entered.

S209: The frequency channel reuse scheme with lowest transmit powers, or lowest power consumption, in the set of candidate frequency channel reuse schemes is selected.

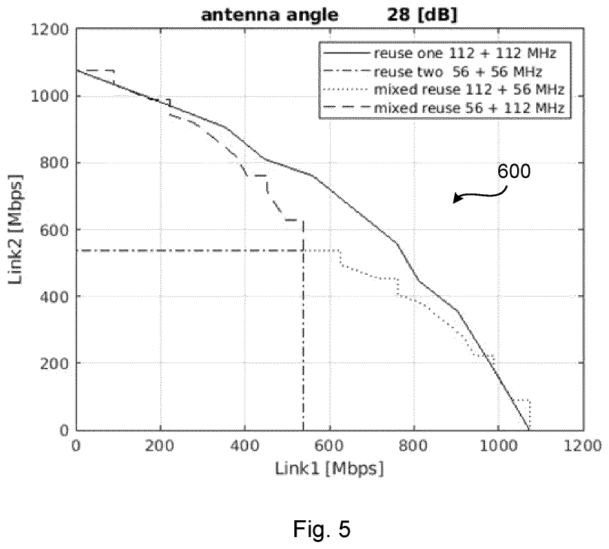

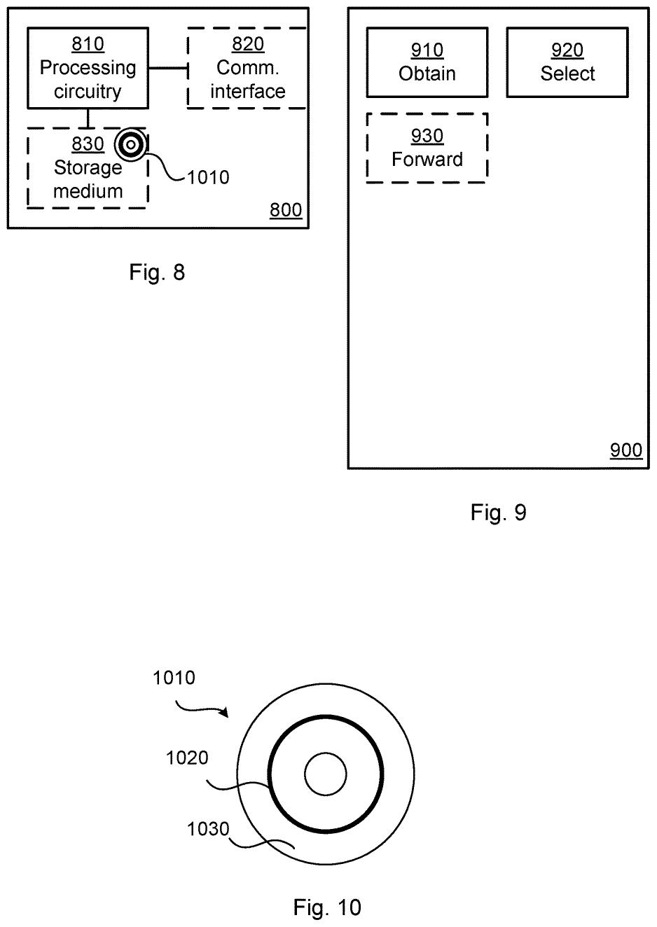

FIG. 8 schematically illustrates, in terms of a number of functional units, the components of a network control unit 800 according to an embodiment. Processing circuitry 810 is provided using any combination of one or more of a suitable central processing unit (CPU), multiprocessor, microcontroller, digital signal processor (DSP), etc., capable of executing software instructions stored in a computer program product 1010 (as in FIG. 10), e.g. in the form of a storage medium 830. The processing circuitry 810 may further be provided as at least one application specific integrated circuit (ASIC), or field programmable gate array (FPGA).

Particularly, the processing circuitry 810 is configured to cause the network control unit 800 to perform a set of operations, or steps, as disclosed above. For example, the storage medium 830 may store the set of operations, and the processing circuitry 810 may be configured to retrieve the set of operations from the storage medium 830 to cause the network control unit 800 to perform the set of operations. The set of operations may be provided as a set of executable instructions.

Thus the processing circuitry 810 is thereby arranged to execute methods as herein disclosed. The storage medium 830 may also comprise persistent storage, which, for example, can be any single one or combination of magnetic memory, optical memory, solid state memory or even remotely mounted memory. The network control unit 800 may further comprise a communications (comm.) interface 820 at least configured for communications with other entities, functions, nodes, and devices, such as the transceiver points 110a:110g in FIG. 1. As such the communications interface 820 may comprise one or more transmitters and receivers, comprising analogue and digital components. The processing circuitry 810 controls the general operation of the network control unit 800 e.g. by sending data and control signals to the communications interface 820 and the storage medium 830, by receiving data and reports from the communications interface 820, and by retrieving data and instructions from the storage medium 830. Other components, as well as the related functionality, of the network control unit 800 are omitted in order not to obscure the concepts presented herein.

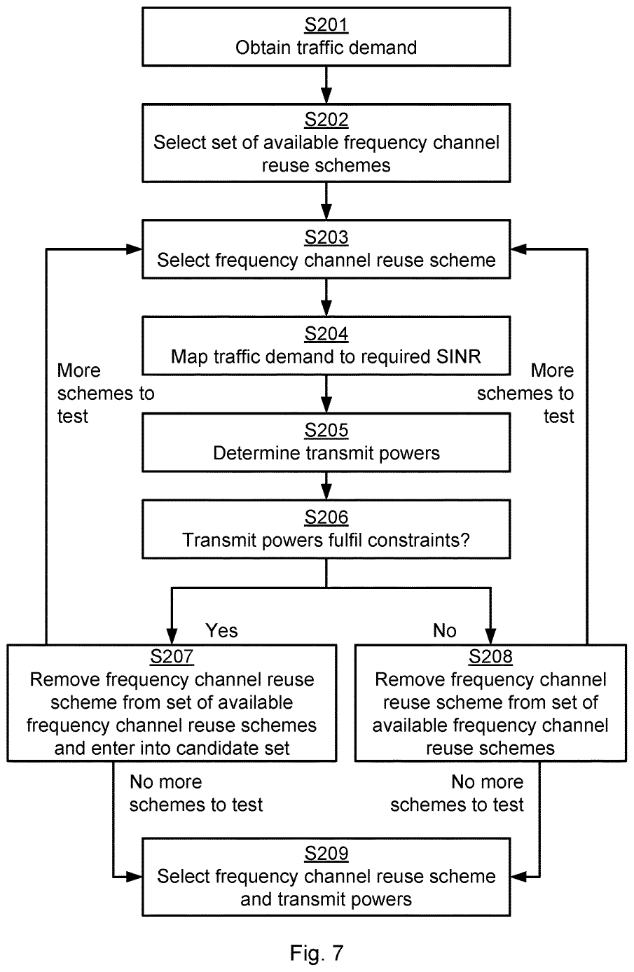

FIG. 9 schematically illustrates, in terms of a number of functional modules, the components of a network control unit 900 according to an embodiment. The network control unit 900 of FIG. 9 comprises a number of functional modules; an obtain module 910 configured to perform step S102, and a select module 920 configured to perform step S104. The network control unit 900 of FIG. 9 may further comprise a number of optional functional modules, such as a forward module 930 configured to perform step S106. In general terms, each functional module 910:930 may in one embodiment be implemented only in hardware and in another embodiment with the help of software, i.e., the latter embodiment having computer program instructions stored on the storage medium 830 which when run on the processing circuitry makes the network control unit 130, 800, 900 perform the corresponding steps mentioned above in conjunction with FIG. 9. It should also be mentioned that even though the modules correspond to parts of a computer program, they do not need to be separate modules therein, but the way in which they are implemented in software is dependent on the programming language used. Preferably, one or more or all functional modules 910:930 may be implemented by the processing circuitry 810, possibly in cooperation with the communications interface 820 and/or the storage medium 830. The processing circuitry 810 may thus be configured to from the storage medium 830 fetch instructions as provided by a functional module 910:930 and to execute these instructions, thereby performing any steps as disclosed herein.

The network control unit 130, 800, 900 may be provided as a standalone device or as a part of at least one further device. A first portion of the instructions performed by the network control unit 130, 800, 900 may be executed in a first device, and a second portion of the of the instructions performed by the network control unit 130, 800, 900 may be executed in a second device; the herein disclosed embodiments are not limited to any particular number of devices on which the instructions performed by the network control unit 130, 800, 900 may be executed. Hence, the methods according to the herein disclosed embodiments are suitable to be performed by a network control unit 130, 800, 900 residing in a cloud computational environment. Therefore, although a single processing circuitry 810 is illustrated in FIG. 8 the processing circuitry 810 may be distributed among a plurality of devices, or nodes. The same applies to the functional modules 910:930 of FIG. 9 and the computer program 1020 of FIG. 10.

FIG. 10 shows one example of a computer program product 1010 comprising computer readable storage medium 1030. On this computer readable storage medium 1030, a computer program 1020 can be stored, which computer program 1020 can cause the processing circuitry 810 and thereto operatively coupled entities and devices, such as the communications interface 820 and the storage medium 830, to execute methods according to embodiments described herein. The computer program 1020 and/or computer program product 1010 may thus provide means for performing any steps as herein disclosed.

In the example of FIG. 10, the computer program product 1010 is illustrated as an optical disc, such as a CD (compact disc) or a DVD (digital versatile disc) or a Blu-Ray disc. The computer program product 1010 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1020 is here schematically shown as a track on the depicted optical disk, the computer program 1020 can be stored in any way which is suitable for the computer program product 1010.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for selecting a frequency channel reuse scheme, and transmit powers, for a fixed wireless network, wherein at least partly overlapping frequency channels are available for communication over wireless links in the fixed wireless network, wherein the method is performed by a network control unit, and wherein the method comprises:
obtaining information of interference among the wireless links, traffic demand per wireless link, and link gain per wireless link; and
selecting the frequency channel reuse scheme by determining which of the frequency channels to be allocated to which of the wireless links, and determining the transmit powers to be used for each of the wireless links, based on the obtained information.

2. The method according to claim 1, wherein the frequency channel reuse scheme is selected from a set of frequency channel reuse schemes available for the fixed wireless network.

3. The method according to claim 2, wherein the method comprises evaluating different frequency channel reuse schemes selected from the set of available frequency channel reuse schemes and determining one set of transmit powers to be used for each of the wireless links for each of the evaluated frequency channel reuse schemes.

4. The method according to claim 3, wherein the frequency channel reuse scheme for which the set of transmit powers is lowest is selected.

5. The method according to claim 1, wherein the transmit powers are conditioned to be within a power interval, wherein the power interval depends on which number of radio units are available per wireless link.

6. The method according to claim 3, wherein, when the set of transmit powers for all evaluated frequency channel reuse schemes are determined to be outside the power interval, the traffic demand per wireless link is reduced until the transmit powers for at least one of the evaluated frequency channel reuse schemes are determined to be inside the power interval.

7. The method according to claim 2, wherein each of the different frequency channel reuse schemes is associated with capacity characteristics provided per antenna discrimination, and wherein which of the frequency channel reuse schemes that are evaluated is determined based on the capacity characteristics and the antenna discrimination.

8. The method according to claim 7, wherein the antenna discrimination corresponds to the interference among the wireless links.

9. The method according to claim 1, wherein the transmit powers further are determined based on thermal noise power per frequency channel and per wireless link.

10. The method according to claim 1, wherein the transmit powers are determined by solving equation systems, where there are as many equation systems as frequency channels, and as many equations per equation system as there are wireless links.

11. The method according to claim 10, wherein, in the equation systems, the traffic demand per wireless link is represented by a respective signal to interference plus noise ratio (SINR) value.

12. The method according to claim 11, wherein the transmit powers are determined by solving:
$$\frac{{h}_{li , li , cm} + {P}_{l i , c m}}{{\sum }_{j , j \neq i} {h}_{l j , li , cm} {P}_{lj , cm} + {n}_{l i , c m}} = {SINR}_{req , li , cm}$$
for P_{li,cm} and P_{lj,cm}, where h_{li,li,cm} is total link gain for link i for frequency channel m, h_{lj,li,cm} is total link gain between link j and i for frequency channel m, P_{li,cm} and P_{lj,cm} are transmit powers for frequency channel m of link i and j, respectively, n_{li,cm} is thermal noise power for link i and frequency channel m, and SINR_{req,li,cm} is the SINR for link i and frequency channel m.

13. The method according to claim 1, wherein each of the frequency channels corresponds to a carrier.

14. The method according to claim 1, wherein the wireless links extend between transceiver points, and wherein the method further comprises:
forwarding information of the selected frequency channel reuse scheme to the transceiver points.

15. The method according to claim 1, wherein the fixed wireless network is any of: a microwave network, a fixed wireless access network, or a fixed wireless backhaul network.

16. A network control unit for selecting a frequency channel reuse scheme, and transmit powers, for a fixed wireless network, wherein at least partly overlapping frequency channels are available for communication over wireless links in the fixed wireless network, the network control unit comprising processing circuitry, the processing circuitry being configured to cause the network control unit to:
obtain information of interference among the wireless links, traffic demand per wireless link, and link gain per wireless link; and
select the frequency channel reuse scheme by determining which of the frequency channels to be allocated to which of the wireless links, and determining the transmit powers to be used for each of the wireless links, based on the obtained information.

17. A network control unit for selecting a frequency channel reuse scheme, and transmit powers, for a fixed wireless network, wherein at least partly overlapping frequency channels are available for communication over wireless links in the fixed wireless network, the network control unit comprising:
an obtain module configured to obtain information of interference among the wireless links, traffic demand per wireless link, and link gain per wireless link; and
a select module configured to select the frequency channel reuse scheme by determining which of the frequency channels to be allocated to which of the wireless links, and determining the transmit powers to be used for each of the wireless links, based on the obtained information.

18. The network control unit according to claim 16, wherein the frequency channel reuse scheme is selected from a set of frequency channel reuse schemes available for the fixed wireless network.

19. A computer program product for selecting a frequency channel reuse scheme, and transmit powers, for a fixed wireless network, wherein at least partly overlapping frequency channels are available for communication over wireless links in the fixed wireless network, the computer program product comprising a non-transitory computer readable medium storing computer code which, when run on processing circuitry of a network control unit, causes the network control unit to:
obtain information of interference among the wireless links, traffic demand per wireless link, and link gain per wireless link; and
select the frequency channel reuse scheme by determining which of the frequency channels to be allocated to which of the wireless links, and determining the transmit powers to be used for each of the wireless links, based on the obtained information.

20. The computer program product according to claim 19, wherein the frequency channel reuse scheme is selected from a set of frequency channel reuse schemes available for the fixed wireless network.
